(19) United States
(12) Patent Application Publication
(10) Pub. No.: US 2020/0311621 A1
(43) Pub. Date: Oct. 1, 2020

(54) MANAGEMENT DEVICE, MANAGEMENT METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Ryoma Taguchi, Tokyo (JP); Yuta Takada, Tokyo (JP)

(21) Appl. No.: 16/822,051

(22) Filed: Mar. 18, 2020

(30) Foreign Application Priority Data
Mar. 29, 2019 (JP) 2019-068976

(51) Int. Cl. G06Q 10/02; G07C 9/38; G06Q 10/06

(52) U.S. Cl. CPC G06Q 10/02; G07C 9/38; G05D 1/0088; G06Q 2240/00; G06Q 10/06315

(57) ABSTRACT

A management device includes an acquirer configured to acquire a usage status of a parking lot, An information processor configured to refer to the usage status acquired by the acquirer and, when a first vehicle having entered a facility including a parking lot cannot use the parking lot within predetermined time after the entry, to receive a first post-entry reservation for a use of the parking lot of the first vehicle, and a provider configured to provide a user of the first vehicle with first information on the first post-entry reservation received by the information processor.

### CROSS-REFERENCE TO RELATED APPLICATION

Priority is claimed on Japanese Patent Application No. 2019-068976, filed Mar. 29, 2019, the content of which is incorporated herein by reference.

### BACKGROUND

### Field

The present invention relates to a management device, a management method, and a storage medium.

### Description of Related Art

Conventionally, a parking lot reservation management device which determines whether there is an overlap between a reserved entry time and a reserved use time of a reserved vehicle and a scheduled entry time and a scheduled use time according to a reservation request, and determines whether the reservation request can be received has been disclosed (Japanese Unexamined Patent Application, First Publication No. H11-328589).

However, in the conventional technologies described above, no consideration has been given to vehicles using the parking lot without reservations. For this reason, the convenience of the parking-lot users may be low in some cases.

### SUMMARY

The present invention has been made in view of such circumstances, and an object thereof is to provide a management device, a management method, and a storage medium that are highly convenient for users.

The management device, the management method, and the storage medium according to the present invention have adopted the following configuration.

(1): A management device according to one aspect of the present invention is a management device which includes an acquirer configured to acquire a usage status of a parking lot, an information processor configured to refer to the usage status acquired by the acquirer and, when a first vehicle having entered a facility including a parking lot cannot use the parking lot within a predetermined time after the entry, to receive a first post-entry reservation for a use of the parking lot of the first vehicle, and a provider configured to provide a user of the first vehicle with first information on the first post-entry reservation received by the information processor.

(2): In the aspect of (1) described above, the management device further includes a controller configured to allow the first vehicle to use the parking lot in a case in which the first vehicle of the user provided with the first information has exited from the facility and has entered the facility at a time according to the first information.

(3): In the aspect of (2) described above, the first vehicle is a vehicle which has not made a pre-entry reservation for a use of the parking lot performed before entry, and the controller, when a second vehicle of a user who has made the pre-entry reservation has entered the facility at a time according to the pre-entry reservation, is configured to allow the second vehicle to use the parking lot.

(4): In the aspect of (2) or (3) described above, a time according to the first information is a time in which a parking space in which the first vehicle can park is present in the parking lot, and a priority level of the first post-entry reservation is higher than a priority level of a second post-entry reservation received after another vehicle has entered the facility.

(5): In the aspect of any one of (1) to (4) described above, the management device further includes a provider configured to refer to the first post-entry reservation, a third post-entry reservation which has a higher priority level than the first post-entry reservation for the use of the parking lot and is received after another vehicle has entered the facility, and a usage status of the parking lot, and to provide the user with a time during which the first vehicle can use the parking lot.

(6): In the aspect of any one of (1) to (5) described above, the usage status includes a use time included in a pre-entry reservation that is received before a vehicle enters the facility for the use of the parking lot.

(7): In the aspect of any one of (1) to (6) described above, the management device further includes a provider configured to provide the user with information indicating the number of fourth post-entry reservations which have higher priority levels than the first post-entry reservation for the use of the parking lot and are received after another vehicle has entered the facility.

(8): In the aspect of any one of (1) to (7) described above, the first information is information on fifth post-entry reservations received after vehicles have entered the facility, which have an increasing priority level in order of entry into the facility.

(9): In the aspect of any one of (1) to (8) described above, the provider is configured to provide a terminal device of a user or a vehicle used by the user with the first information.

(10): In the aspect of any one of (1) to (9) described above, the provider is configured to provide the terminal device of the user or the vehicle used by the user with a time according to the first information during which the first vehicle can use the parking lot.

(11): A management method according to another aspect of the present invention is a management method which includes, by a computer, acquiring a usage status of a parking lot, referring to the acquired usage status, and, when a first vehicle having entered a facility including a parking lot cannot use the parking lot within a predetermined time after the entry, receiving a first post-entry reservation for a use of the parking lot of the first vehicle, and providing a user of the first vehicle with first information on the received first post-entry reservation.

(12): A non-transitory computer-readable storage medium that is configured to store a computer program to be executed by a computer to perform at least: acquiring a usage status of a parking lot, refer to the acquired usage status, and, when a first vehicle having entered a facility including a parking lot cannot use the parking lot within a predetermined time after the entry, receiving a first post-entry reservation for a use of the parking lot of the first vehicle, and providing a user of the first vehicle with first information on the received first post-entry reservation.

According to (1) to (6), (8), (9), and (12), it is possible to improve the convenience of the user.

According to (7), the management device is configured to provide the user with information indicating the number of post-entry reservations which have higher priority levels than the first post-entry reservation for the use of the parking lot and are received after another vehicle has entered the facility, and thereby the user can recognize his or her own priority level.

According to (10), since the management device is configured to provide the terminal device of the user or the vehicle used by the user with time according to first information during which the first vehicle can use the parking lot, the user can ascertain the time during which the parking lot can be used.

### BRIEF DESCRIPTION OF THE DRAWINGS

FIG. 1 is a configuration diagram of a parking lot management system 1 including a vehicle system.

FIG. 2 is a diagram which shows an example of a functional configuration of the vehicle system.

FIG. 3 is a functional configuration diagram of a first controller and a second controller.

FIG. 4 is a diagram which schematically shows a scene in which an autonomous parking event is executed.

FIG. 5 is a diagram which shows an example of a configuration of a parking lot management device.

FIG. 6 is a diagram which shows an example of content of pre-entry reservation information.

FIG. 7 is a flowchart which shows an example of a flow of processing executed by a parking lot management device and a specific gate device when post-entry reservation information is generated.

FIG. 8 is a diagram which shows an example of content of the post-entry reservation information.

FIG. 9 is a diagram which shows an example of an image displayed on a display of the specific gate device.

FIG. 10 is a diagram which shows an example of an image displayed on the display of a terminal device.

FIG. 11 is a diagram which shows an example of a scene in which processing of step S104 is performed.

FIG. 12 is a diagram which shows an example of a scene in which processing of a post-entry reservation is performed.

FIG. 13 is a flowchart which shows an example of a flow of processing executed when a vehicle M having made a post-entry reservation enters.

FIG. 14 is a diagram which shows an example of a facility configuration of a second embodiment.

FIG. 15 is a diagram which shows an example of a hardware configuration of an automated driving control device of the embodiment.

### DETAILED DESCRIPTION

Hereinafter, embodiments of a management device, a management method, and a storage medium according to the present invention will be described with reference to the drawings.

### First Embodiment

### Overall Configuration

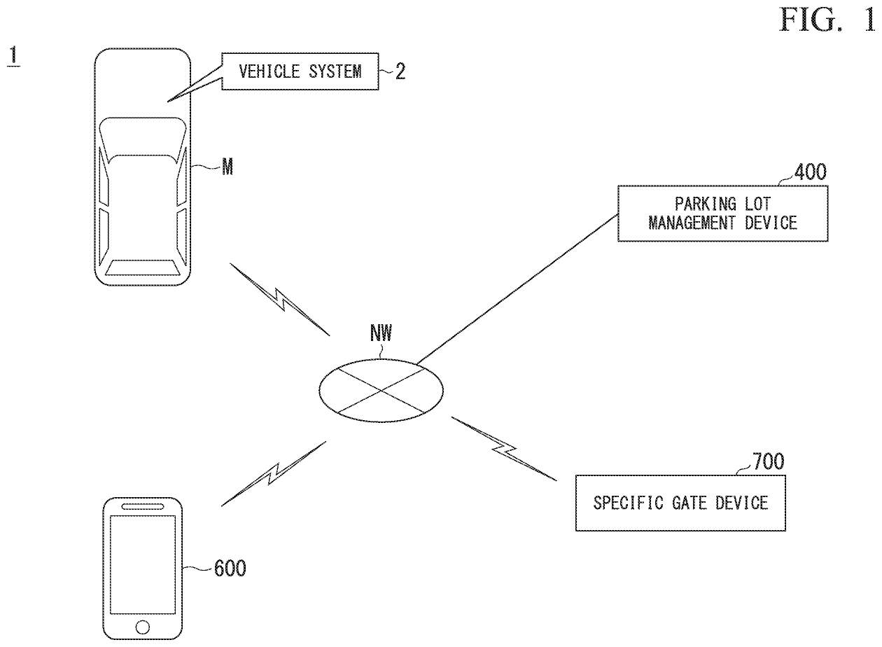

FIG. 1 is a configuration diagram of a parking lot management system 1 including a vehicle system 2. The parking lot management system 1 includes, for example, one or more vehicles (hereinafter, a vehicle M) equipped with the vehicle system 2, one or more parking lot management devices 400, one or more terminal devices 600, and one or more specific gate devices 700. These components can communicate with each other via a network NW. The network NW includes a cellular network, a Wi-Fi network, the Internet, a wide area network (WAN), a local area network (LAN), a public line, a provider device, a dedicated line, a wireless base station, and the like. These components may directly perform wireless communication without going through the network NW. Details of the vehicle M, the parking lot management device 400, and the specific gate device 700 will be described below.

The terminal device 600 is, for example, a terminal device that can be carried by a user, such as a smartphone, a tablet terminal, and a personal computer. The terminal device 600 communicates with the vehicle M and transmits a user request to the vehicle M or performs push notification based on information received from the vehicle M or the parking lot management device 400. The terminal device 600 communicates with a reservation management device 500 and makes a reservation for parking the vehicle M in a predetermined parking lot.

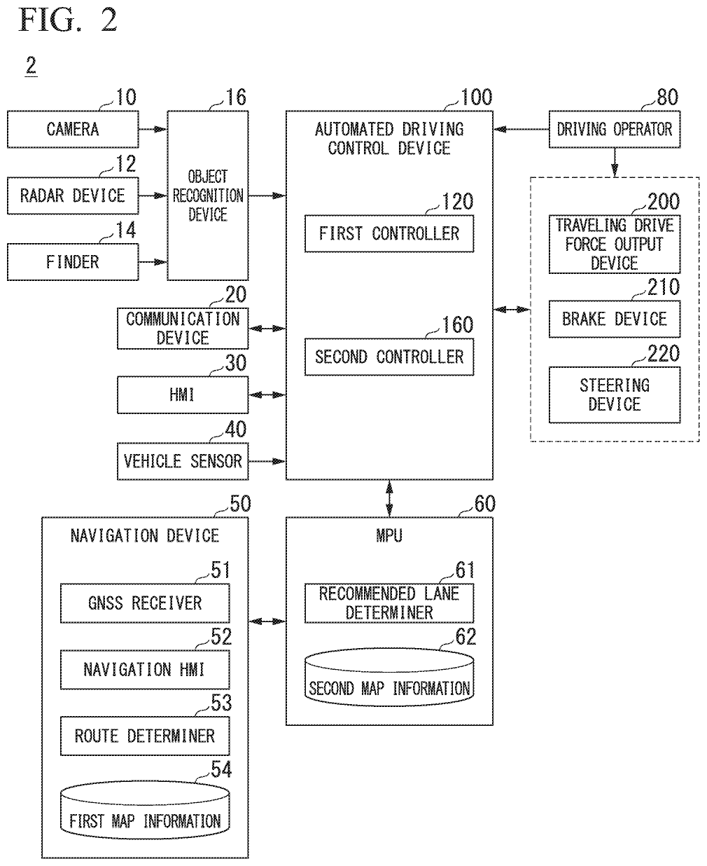

FIG. 2 is a diagram which shows an example of a functional configuration of the vehicle system 2. A vehicle on which the vehicle system 2 is mounted is, for example, two-wheel, three-wheel, or four-wheel vehicle, and a driving source thereof is an internal combustion engine such as a diesel engine or a gasoline engine, an electric motor, or a combination thereof. The electric motor operates using electric power generated by a generator connected to the internal combustion engine, or electric power discharged from a secondary battery or a fuel cell.

The vehicle system 2 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a traveling drive force output device 200, a brake device 210, and a steering device 220. These devices or apparatuses are connected to each other by a multiplex communication line such as a controller area network (CAN) communicator line, a serial communication line, a wireless communication network, or the like. The configuration shown in FIG. 1 is merely an example, and a part of the configuration may be omitted or another configuration may be added.

The camera 10 is, for example, a digital camera using a solid-state imaging device such as a charge coupled device (CCD) or a complementary metal oxide semiconductor (CMOS). The camera 10 is attached to an arbitrary position of a vehicle on which the vehicle system 2 is mounted. The vehicle system 2 includes, for example, a plurality of cameras 10. The camera 10 is attached to, for example, an upper part of the front windshield, a rear surface of the rear view mirror, or the like, and captures an image of the front of the vehicle. The camera 10 is attached to, for example, an upper part of a rear windshield, near a license plate on a rear outside of the vehicle, or near a trunk door on the rear outside of the vehicle, and captures an image of the rear of the vehicle. The camera 10 periodically and repeatedly captures images of a vicinity of the vehicle M. The camera 10 may also be a stereo camera.

The radar device 12 radiates radio waves such as millimeter waves to the vicinity of the vehicle M, and detects at least a position (a distance and an orientation) of an object by detecting radio waves (reflected waves) reflected by the object. The radar device 12 is attached to an arbitrary position of the vehicle M. The radar device 12 may detect the position and a speed of the object using a frequency modulated continuous wave (FM-CW) method.

The finder 14 is a light detection and range (LIDAR). The finder 14 radiates light to the vicinity of the vehicle M and measures scattered light. The finder 14 detects a distance to the object on the basis of time from light emission and light reception. The radiated light is, for example, pulsed laser light. The finder 14 is attached to an arbitrary position of the vehicle M.

The object recognition device 16 performs sensor fusion processing on a result of detection performed by some or all of the camera 10, the radar device 12, and the finder 14, and recognizes the position, type, speed, and the like of the object. The object recognition device 16 outputs a result of the recognition to the automated driving control device 100. The object recognition device 16 may output the results of detection by the camera 10, the radar device 12, and the finder 14 to the automated driving control device 100 as they are. The object recognition device 16 may be omitted from the vehicle system 2.

The communication device 20 uses, for example, a cellular network, a Wi-Fi network, a Bluetooth (a registered trademark), a dedicated short range communication (DSRC), or the like, and communicates with another vehicle or a parking lot management device (to be described below) present in the vicinity of the vehicle M or various types of server devices.

The HMI 30 presents various types of information to an occupant of the vehicle M and receives an input operation from the occupant. The HMI 30 includes various display devices, speakers, buzzers, touch panels, switches, keys, and the like.

The vehicle sensor 40 includes a vehicle speed sensor that detects the speed of the vehicle M, an acceleration sensor that detects the acceleration, a yaw rate sensor that detects an angular speed around a vertical axis, an orientation sensor that detects a direction of the vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the vehicle M on the basis of a signal received from a GNSS satellite. The position of the vehicle M may be identified or supplemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route (hereinafter, a route on a map) from the position (or an arbitrary input position) of the vehicle M identified by the GNSS receiver 51 to a destination input from the occupant using the navigation HMI 52 with reference to the first map information 54. The first map information 54 is, for example, information in which a road shape is expressed by a link indicating a road and a node connected by the link. The first map information 54 may include curvature of a road, point of interest (POI) information, and the like. The route on a map is output to the MPU 60. The navigation device 50 may perform route guidance using the navigation HMI 52 on the basis of the route on a map. The navigation device 50 may be realized by, for example, a function of a terminal device such as a smart phone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in the storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane to travel from the left. When there is a branch point in the route on a map, the recommended lane determiner 61 determines a recommended lane such that the vehicle M travels in a reasonable route for traveling to a branch destination.

The second map information 62 is map information with higher accuracy than the first map information 54. The second map information 62 includes, for example, information on a center of a lane or information on a boundary of the lane. The second map information 62 may include road information, traffic regulation information, address information (addresses/postal codes), facility information, telephone number information, and the like. The second map information 62 may be updated at any time by the communication device 20 communicating with another device.

The driving operator 80 includes, for example, an accelerator pedal, a brake pedal, a shift lever, a steering wheel, a modified steer, a joystick, and other operators. A sensor that detects an operation amount or a presence or absence of an operation is attached to the driving operator 80, and this detection result is output to the automated driving control device 100 or some or all of the traveling drive force output device 200, the brake device 210, and the steering device 220.

The automated driving control device 100 includes, for example, a first controller 120 and a second controller 160. Each of the first controller 120 and the second controller 160 is realized, for example, by a hardware processor such as a central processing unit (CPU) executing a program (software). Some or all of these components may be realized by hardware (a circuit; including circuitry) such as a large scale integration (LSI), an application specific integrated circuit (ASIC), a field-programmable gate array (FPGA), and a graphics processing unit (GPU), and may also be realized by a cooperation of software and hardware. The program may be stored in advance in a storage device (a storage device including a non-transitory storage medium) such as an HDD or a flash memory of the automated driving control device 100, or may be stored in a detachable storage medium such as a DVD or a CD-ROM and installed in the HDD or the flash memory of the automated driving control device 100 by the storage medium (the non-transitory storage medium) being mounted on a drive device.

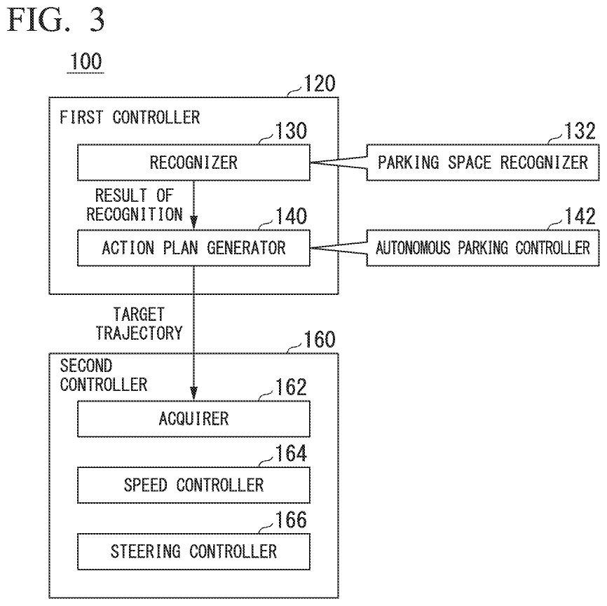

FIG. 3 is a functional configuration diagram of the first controller 120 and the second controller 160. The first controller 120 includes, for example, a recognizer 130 and an action plan generator 140. The first controller 120 realizes, for example, a function based on artificial intelligence (AI) and a function based on a model given in advance in parallel. For example, a function of “recognizing an intersection” may be realized by executing a recognition of an intersection by deep learning or the like and a recognition based on conditions (including pattern matching signals, road markings, and the like) given in advance in parallel and comprehensively evaluating the both by scoring them. As a result, a reliability of automated driving is guaranteed.

The recognizer 130 recognizes situations such as the position, speed and acceleration of the object in the vicinity of the vehicle M on the basis of information input from the camera 10, the radar device 12, and the finder 14 via the object recognition device 16. The positon of the object is, for example, recognized as a position on absolute coordinates having the origin at a representative point (a center of gravity, a center of a drive axis, or the like) of the vehicle M, and is used for control. The position of the object may be represented by a representative point such as a center of gravity or a corner of the object, or may be represented by an expressed area. A “state” of the object may include the acceleration or jerk of the object, or an “action state” (for example, whether a lane is changed or is intended to be changed).

The recognizer 130 recognizes, for example, a lane (traveling lane) in which the vehicle M is traveling. For example, the recognizer 130 recognizes a traveling lane by comparing a pattern (for example, an array of solid lines and dashed lines) of a road section line obtained from the second map information 62 with a pattern of a road section line in the vicinity of the vehicle M recognized from an image captured by the camera 10. The recognizer 130 may recognize a traveling lane by recognizing not only a road section line but also a traveling road boundary (road boundary) including road section lines, road shoulders, curbs, median strips, guardrails, and the like. In this recognition, the position of the vehicle M acquired from the navigation device 50 and a result of processing performed by the INS may be added. The recognizer 130 recognizes temporary stop lines, obstacles, red light, tollgates, or other road events.

When a traveling lane is recognized, the recognizer 130 recognizes the position and posture of the vehicle M with respect to the traveling lane. The recognizer 130 may recognize, for example, a deviation of a reference point of the vehicle M from a lane center and an angle formed with respect to a line connecting the lane centers in a traveling direction of the vehicle M as the relative position and posture of the vehicle M with respect to the traveling lane. Instead, the recognizer 130 may recognize a position and the like of the reference point of the vehicle M with respect to either side end (a road section line or a road boundary) of the traveling lane as the relative position of the vehicle M with respect to the traveling lane.

The recognizer 130 includes a parking space recognizer 132 that is started in an autonomous parking event to be described below. Details of functions of the parking space recognizer 132 will be described below.

In principle, the action plan generator 140 travels on a recommended lane determined by the recommended lane determiner 61, and furthermore, generates a target trajectory in which the vehicle M will automatically (without depending on an operation of the driver) travel to be able to cope with the vicinity situation of the vehicle M. The target trajectory includes, for example, a speed element. For example, the target trajectory is expressed as a sequence of points (orbit points) to be reached by the vehicle M. The orbit points are points to be reached by the vehicle M for each predetermined traveling distance (for example, about several [m]) in a road distance, and separately from this, a target speed and a target acceleration for each predetermined sampling time (for example, about 0 commas[sec]) are generated as a part of the target trajectory. The orbit points may be positions to be reached by the vehicle M at a corresponding sampling time for each predetermined sampling time. In this case, the information on the target speed and the target acceleration is expressed by an interval between the orbit points.

The action plan generator 140 may set an automated driving event in generation of a target trajectory. Examples of the automated driving event include a constant-speed traveling event, a low-speed following traveling event, a lane change event, a branching event, a merging event, a takeover event, an autonomous parking event in which unmanned traveling or automated traveling is performed to park in valet parking and the like, and the like. The action plan generator 140 generates a target trajectory in accordance with a started event. The action plan generator 140 includes an autonomous parking controller 142 which is started when an autonomous parking event is executed. Details of functions of the autonomous parking controller 142 will be described below.

The second controller 160 controls the traveling drive force output device 200, the brake device 210, and the steering device 220 such that the vehicle M passes through the target trajectory generated by the action plan generator 140 at a scheduled time.

Returning to FIG. 2, the second controller 160 includes, for example, an acquirer 162, a speed controller 164, and a steering controller 166. The acquirer 162 acquires information on the target trajectory (orbit points) generated by the action plan generator 140 and stores it in a memory (not shown). The speed controller 164 controls the traveling drive force output device 200 or the brake device 210 on the basis of a speed element associated with the target trajectory stored in the memory. The steering controller 166 controls the steering device 220 in accordance with a bending condition of the target trajectory stored in the memory. Processing of the speed controller 164 and the steering controller 166 is realized by, for example, a combination of feed forward control and feedback control. As an example, the steering controller 166 executes a combination of the feed forward control in accordance with curvature of a road in front of the vehicle M and the feedback control based on a deviation from the target trajectory.

The traveling drive force output device 200 outputs a traveling drive force (torque) for a traveling of a vehicle to drive wheels. The traveling drive force output device 200 includes, for example, a combination of an internal combustion engine, an electric motor, a transmission, and the like, and an electronic control unit (ECU) that controls these. The ECU controls the constituents described above according to information input from the second controller 160 or information input from the driving operator 80.

The brake device 210 includes, for example, a brake caliper, a cylinder that transmits a hydraulic pressure to the brake caliper, an electric motor that generates a hydraulic pressure to the cylinder, and a brake ECU. The brake ECU controls the electric motor according to the information input from the second controller 160 or the information input from the driving operator 80 such that a brake torque corresponding to a braking operation is output to each wheel. The brake device 210 may include, as a backup, a mechanism that transmits the hydraulic pressure generated by an operation of the brake pedal included in the driving operator 80 to the cylinder via a master cylinder. The brake device 210 is not limited to the configuration described above, and may be an electronically controlled hydraulic brake device that controls an actuator according to the information input from the second controller 160 and transmits the hydraulic pressure of the master cylinder to the cylinder.

The steering device 220 includes, for example, a steering ECU and an electric motor. The electric motor changes a direction of the steering wheel by, for example, applying a force to a rack and pinion mechanism. The steering ECU drives the electric motor and changes the direction of the steering wheel according to the information input from the second controller 160 or the information input from the driving operator 80.

### Autonomous Parking Event-at the Time of Entrance

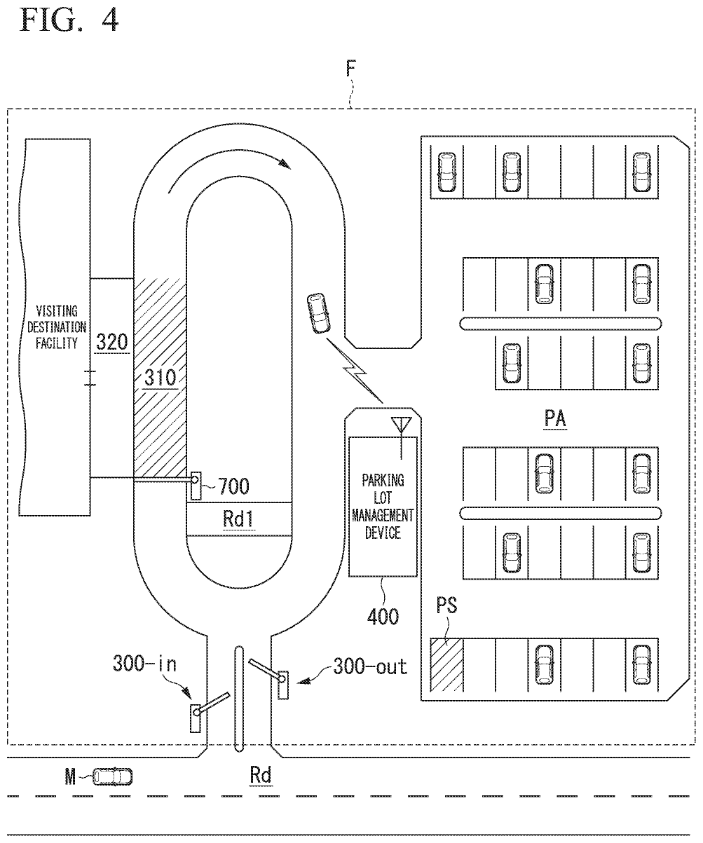

The autonomous parking controller 142 causes the vehicle M to park in a parking space on the basis of, for example, information acquired from the parking lot management device 400 by the communication device 20. FIG. 4 is a diagram which schematically shows a scene in which an autonomous parking event is executed. A case in which the vehicle visits a facility F will be described. The facility F includes a parking lot PA, a visiting destination facility, a road in the facility from a vicinity of the visiting destination facility to the parking lot PA, and the like. In a route from a road Rd to a visiting destination facility, gates 300-in and 300-out are provided. The vehicle M proceeds to a stop area 310 by passing through the gate 300-in by manual driving or automated driving. The stop area 310 faces a getting-on/off area 320 connected to the visiting destination facility. The getting-on/off area 320 is provided with an eave for avoiding rain and snow.

The specific gate device 700 is provided between the stop area 310 and the gate 300-in. The specific gate device 700 curbs traffic of the vehicle M, for example, when the parking lot is full and the vehicle M which has not made a reservation for the use of the parking lot has reached near the specific gate device 700. When the traffic is curbed, the vehicle M can travel on a U-turn road Rd1 connected to a place located before passing through the specific gate device 700, and pass through the gate 300-out to return to the road Rd. The specific gate device 700 permits the traffic of the vehicle M, for example, when the parking lot is empty or the vehicle M which has made a reservation for the use of the parking lot has reached near the specific gate device 700.

The vehicle M starts an autonomous parking event in which unmanned automated driving is performed to move to a parking space PS in the parking lot PA after the occupant is unloaded at the stop area 310. A start trigger of the autonomous parking event may be, for example, some operations performed by the occupant, or may be a reception of a predetermined signal wirelessly from the parking lot management device 400. The autonomous parking controller 142 controls the communication device 20 such that it transmits a parking request to the parking lot management device 400 when the autonomous parking event is started. Then, the vehicle M moves from the stop area 310 to the parking lot PA according to a guidance of the parking lot management device 400 or while performing sensing by itself.

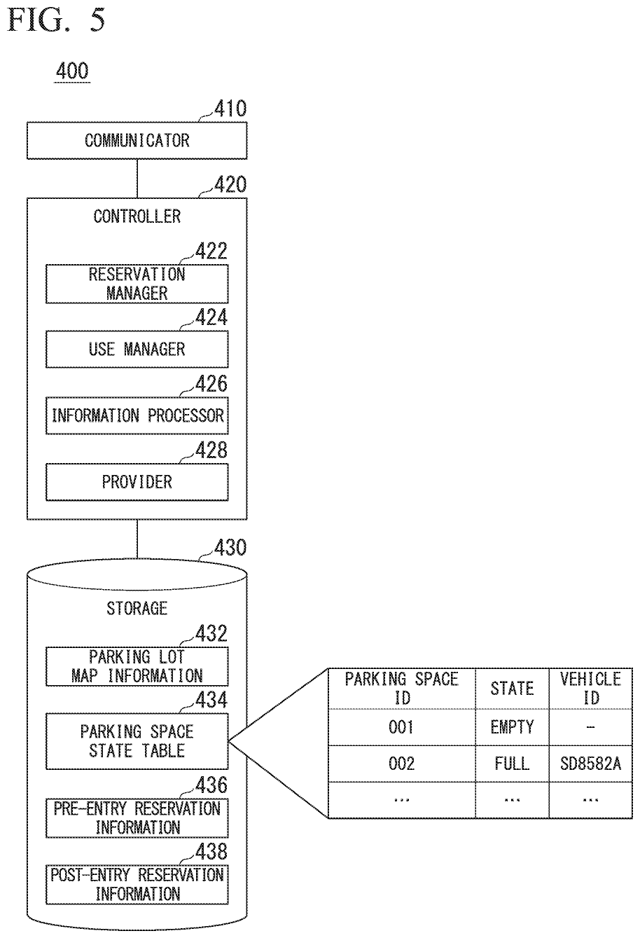

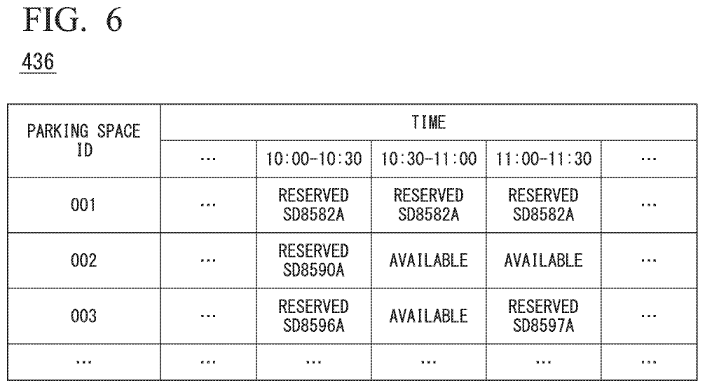

FIG. 5 is a diagram which shows an example of a configuration of the parking lot management device 400. The parking lot management device 400 includes, for example, a communicator 410, a controller 420, and a storage 430. The controller 420 includes, for example, a reservation manager 422, a use manager 424, an information processor 426, and a provider 428. The storage 430 stores, for example, information such as parking lot map information 432, a parking space state table 434, pre-entry reservation information 436 (refer to FIG. 6), and post-entry reservation information 438.

The reservation manager 422 manages reservations for the use of a parking lot on the basis of the user request, the information stored in the storage 430, and the like. The reservation manager 422 mainly acquires a future usage status of the parking lot. The future usage status includes a use time included in a pre-entry reservation for the use of the parking lot, which is received before the vehicle M enters the facility.

The use manager 424 refers to the parking space state table 434 to be described below, and manages a status of the vehicle M parking in the parking lot. The use manager 424 mainly acquires a current usage status of the parking lot. The reservation manager 422 and the use manager 424 are examples of an “acquirer.”

The information processor 426 refers to the usage status, and, when a first vehicle having entered a facility including the parking lot cannot use the parking lot within a predetermined time after the entry, receives a first post-entry reservation for the use of the parking lot of the first vehicle. The first vehicle is a vehicle that has not made a pre-entry reservation for the use of the parking lot to be made before an entry or a vehicle of a user who has made a pre-entry reservation but wishes to use the parking lot earlier than a time designated in the pre-entry reservation. The “usage status” includes one or both of a future usage status of the parking lot and a current usage status of the parking lot. For example, the usage status includes the current usage status of the parking lot (for example, it is full or empty), or the current usage status of the parking lot and the future usage status of the parking lot (for example, a time at which a vehicle is scheduled to park in a parking space and a time at which a vehicle parking in the parking space is scheduled to exit).

The provider 428 provides a user of the first vehicle with first information on the first post-entry reservation received by the information processor 426. Details of the types of processing will be described below.

The communicator 410 wirelessly communicates with the vehicle M and other vehicles. The controller 420 guides the vehicle M to the parking space PS on the basis of information acquired by the communicator 410 and information stored in the storage 430. The parking lot map information 432 is information in which a structure of the parking lot PA is geometrically represented. The parking lot map information 432 includes coordinates for each parking space PS. The parking space state table 434 includes, for example, a state indicating that a parking space is in an empty state or in a full (parking) state, and a vehicle ID that is identification information of a parking vehicle when a parking space is in the full state in association with a parking space ID that is identification information of the parking space PS.

If the communicator 410 receives the parking request from the vehicle M, the controller 420 extracts a parking space PS which is in the empty state with reference to the parking space state table 434, acquires a position of the extracted parking space PS from the parking lot map information 432, and transmits a preferred route to the position of the acquired parking space PS to the vehicle M using the communicator 410. The controller 420 instructs a specific vehicle M to stop or slow down when necessary on the basis of a positional relationship of a plurality of vehicles M such that vehicles M do not proceed to the same position at the same time.

In the vehicle that has received the route, the autonomous parking controller 142 generates a target trajectory based on the route. If a target parking space PS is approached, the parking space recognizer 132 recognizes a parking frame line or the like that partitions the parking space PS, and recognizes a detailed position of the parking space PS to provide it to the autonomous parking controller 142. The autonomous parking controller 142 corrects the target trajectory after receiving this and causes the vehicle M to park in the parking space PS.

### Autonomous Parking Event-at the Time of Exit

The autonomous parking controller 142 and the communication device 20 maintain an operating state even while the vehicle M parks. The autonomous parking controller 142 causes a system of the vehicle M to start and causes the vehicle M to move to the stop area 310, for example, when the communication device 20 receives a pick-up request from a terminal device 600 of the occupant. At this time, the autonomous parking controller 142 controls the communication device 20 such that it transmits a take-off request to the parking lot management device 400. The controller 420 of the parking lot management device 400, similarly to the time of entrance, instructs a specific vehicle to stop or slow down when necessary on the basis of the positional relationship of a plurality of vehicles such that the vehicles do not proceed to the same position at the same time just like at the time of entrance. If the vehicle M is moved to the stop area 310 to allow the occupant to board, the autonomous parking controller 142 stops operating, and thereafter, manual driving or automated driving performed by another functional part is started.

The autonomous parking controller 142 is not limited to the description above, and may find a parking space in the empty state by itself on the basis of a result of detection performed by the camera 10, the radar device 12, the finder 14, or the object recognition device 16 independently of communication, and cause the vehicle M to park in the found parking space.

### Pre-entry Reservation Information

FIG. 6 is a diagram which shows an example of content of the pre-entry reservation information 436. The pre-entry reservation information 436 is, for example, information on a reservation made before a user who wishes to use the parking lot enters the parking lot. The pre-entry reservation information 436 is information in which a parking space ID, a time, and the presence or absence of a reservation are associated with each other. An area defined by the parking space ID and a time of FIG. 6 may be referred to as a column. The reservation manager 422 associates a reserved user ID or a vehicle ID of the user with a column according to a request of the terminal device 600.

### Processing of Generating Post-entry Reservation Information

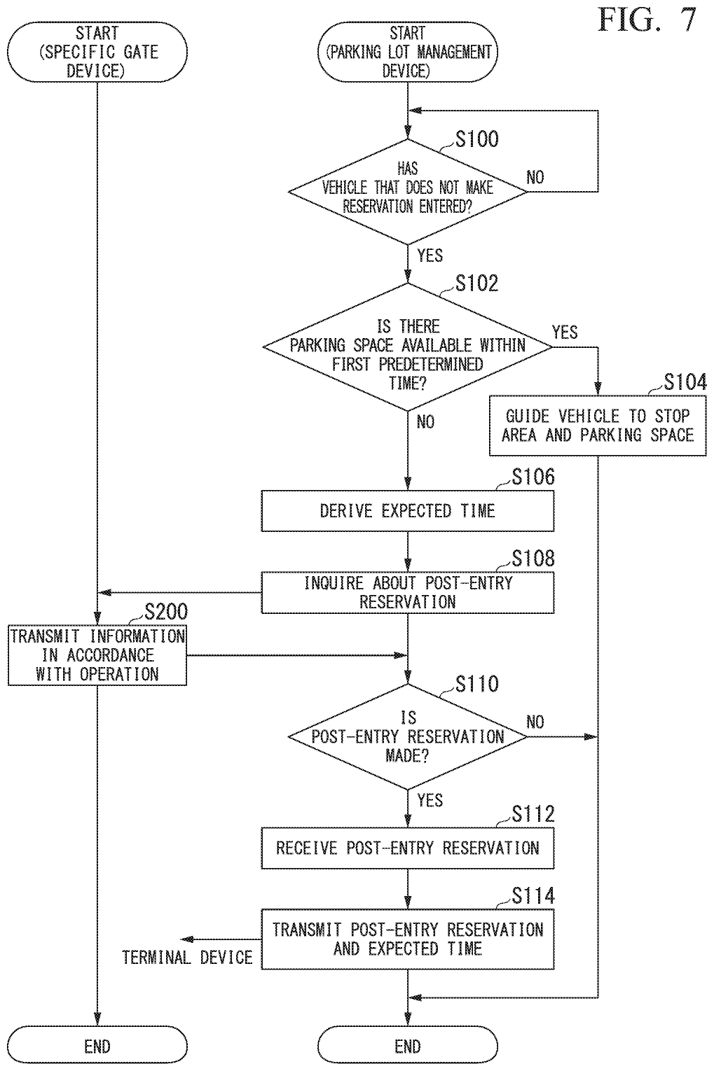

FIG. 7 is a flowchart which shows an example of a flow of processing executed by the parking lot management device 400 and the specific gate device 700 when post-entry reservation information is generated.

First, the use manager 424 determines whether the vehicle M which has not made a reservation has entered (step S100). For example, a camera (not shown) which captures an image of the vehicle M entering the parking lot is provided near the gate 300-in. The use manager 424 analyses the image captured by the camera described above, and identifies a vehicle ID which has entered on the basis of a result of the analysis. For example, the use manager 424 acquires a license plate of the vehicle M, and identifies a vehicle ID or a user ID associated with the acquired license plate in the storage 430. A communication device (not shown) which communicates with the vehicle M entering the parking lot may be provided near the gate 300-in. The communication device communicates with, for example, the vehicle M which has reached near the gate 300-in and acquires the vehicle ID.

Next, the use manager 424 determines whether there is a parking space available within a first predetermined time (step S102). The use manager 424 refers to, for example, the parking space state table 434 and the pre-entry reservation information 436, and determines whether there is an available parking space. When there is no available parking space, the use manager 424 refers to the pre-entry reservation information 436, and determines whether there is a vehicle M that will exit from the parking lot within the first predetermined time from a current time. For example, when there is a parking space available, or when there is a vehicle M that will exit from the parking lot within the first predetermined time from a current time, the use manager 424 determines that there is a parking space available within the first predetermined time. The first predetermined time is a time during which temporary stopping in the stop area 310 or another area is allowed.

When there is a parking space available within the first predetermined time, the controller 420 guides the vehicle M which has entered to the stop area 310 and the parking space (step S104). When a second vehicle of a user who has made a pre-entry reservation has entered a facility F at a time (a time designated in the pre-entry reservation) according to the pre-entry reservation, the controller 420 determines that there is a parking space available within the first predetermined time and allows the second vehicle to use the parking lot. As a result, the vehicle M which has entered parks in the parking lot.

When there is no parking space available within the first predetermined time, the information processor 426 refers to the pre-entry reservation information 436 and the post-entry reservation information 438, and derives an expected time during which the vehicle M which has entered can use the parking lot (step S106).

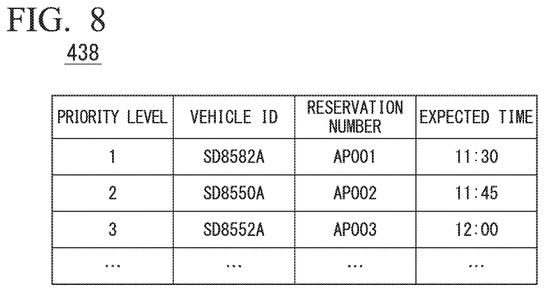

FIG. 8 is a diagram which shows an example of content of the post-entry reservation information 438. The post-entry reservation information is information on reservations for the use of the parking lot received after an entry to the facility F (refer to processing of step 112 and S114 of FIG. 7 to be described below). The post-entry reservation information 438 is information in which a priority level of the vehicle M, a vehicle ID, a reservation number, and an expected time are associated with each other. The priority level of the vehicle M is a priority level related to the post-entry reservation, and the priority level increases in order of arrival at the parking lot.

For example, the information processor 426 refers to the pre-entry reservation information 436 to identify a time at which the vehicle M exits, and refers to the post-entry reservation information 438 to identify a vehicle (a vehicle with a higher priority level) which can enter at the time at which the vehicle exits. When an exit time of a vehicle which has not made a pre-entry reservation can be identified, the information processor 426 derives an expected time on the basis of the post-entry reservation information 438 and the exit time of the vehicle which has not made a pre-entry reservation.

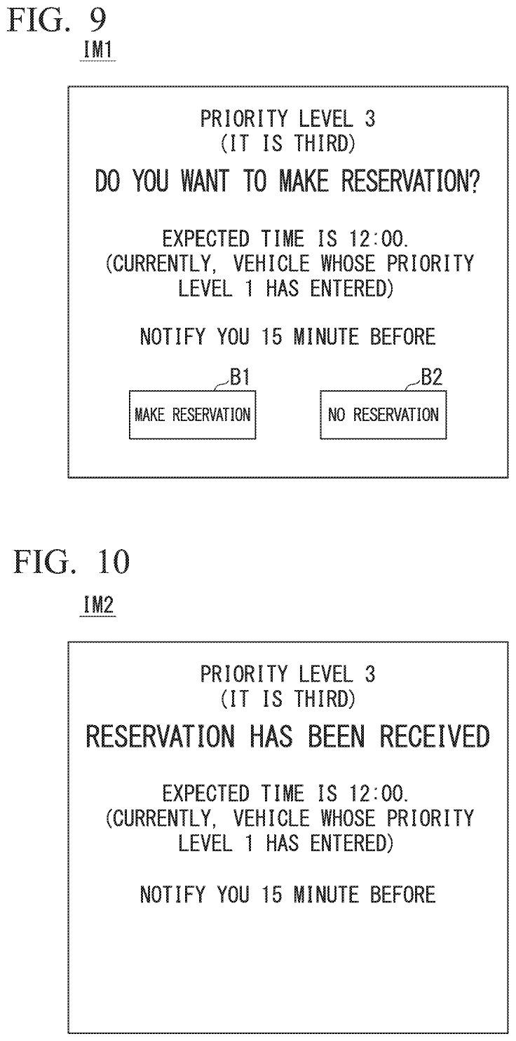

The information processor 426 transmits an inquiry about a post-entry reservation to the specific gate device 700 (step S108). FIG. 9 is a diagram which shows an example of an image IM1 displayed on a display of the specific gate device 700. The display of the specific gate device 700 is, for example, a touch panel-type display. The provider 428 provides a user with information (the image IM1) including information (a priority level 3 (the third) of FIG. 9, and FIG. 10 to be described below) indicating the number of post-entry reservations which have higher priority levels than the first post-entry reservation for the use of the parking lot and are received after another vehicle has entered the facility.

For example, a priority level of a vehicle which has entered, a comment for inquiring whether to make a reservation, an expected time during which the parking lot can be used, a timing at which notification is performed on a vehicle, a button B1 for instructing to make a reservation, a button B2 for instructing not to make a reservation, and the like are displayed in the image IM1.

In the example described above, the image IM1 is described as being displayed on the display of the specific gate device 700, but, instead of (or in addition to) this, the image IM1 may also be displayed on a display with which the vehicle M is equipped or a display of the terminal device 600.

If a user of the vehicle M performs a predetermined operation on the display of the specific gate device 700, the specific gate device 700 transmits information according to the operation to the parking lot management device 400 (step S200). The information according to the operation is information indicating that a post-entry reservation is to be made or information indicating that a post-entry reservation is not to be made.

Next, the information processor 426 determines whether the post-entry reservation has been made on the basis of the information transmitted in step S200 (step S110). When the post-entry reservation has not been made, processing of this flowchart ends.

When the post-entry reservation has been made, the information processor 426 receives the post-entry reservation on the basis of the information transmitted in step S200 (step S112). Reception of the post-entry reservation means that the information processor 426 associates the post-entry reservation of the vehicle with the post-entry reservation information 438. For example, the information processor 426 associates the information in which a priority level, a vehicle ID, a reservation number, and an expected time are associated with each other with the post-entry reservation information 438.

Next, the provider 428 transmits information (first information) indicating that the post-entry reservation has been received to the terminal device 600 (step S114). FIG. 10 is a diagram which shows an example of an image IM2 displayed on the display of the terminal device 600. A priority level of a vehicle which has entered, a comment indicating that the reservation has been received, an expected time during which the parking lot can be used, a timing at which notification is performed on the vehicle, and the like are displayed in the image IM1. The expected time is a time according to first information during which the first vehicle can use the parking lot.

That is, the provider 428 refers to the parking space state table 434, the pre-entry reservation information 436, and the post-entry reservation information 438, and provides the user with a time during which the first vehicle can use the parking lot. Specifically, the provider 428 refers to the first post-entry reservation, a post-entry reservation received after another vehicle having a higher priority level than the first post-entry reservation for the use of the parking lot has entered the facility, and the usage status of the parking lot (for example, the current usage status or the future usage status of the parking lot), and provides the user with time during which the first vehicle can use the parking lot. For example, the provider 428 identifies a time at which a vehicle having parked in a parking space PS will exit, determines that a vehicle having the highest priority level will park in the parking space, and derives a time at which a vehicle of interest can park in the parking space PS by repeating these types of processing. Then, the provider 428 derives an expected time on the basis of a result of the derivation. Accordingly, processing of this flowchart ends.

In step S114, reservation completion information may be transmitted to the specific gate device 700 or the vehicle M. The reservation completion information may be displayed on the display of the specific gate device 700 or the display of the vehicle M, or may be printed on a paper medium by a printer of the specific gate device 700 and the printed paper medium may be provided to the user.

The provider 428 may notify the vehicle M or the terminal device 600 which has made a post-entry reservation of a time at which the parking lot PA can be used or notify the vehicle M or the terminal device 600 of the time at which the parking lot can be used a predetermined time before the time.

According to the processing described above, the parking lot management device 400 receives a reservation after an entry from a vehicle M which has visited the parking lot without a reservation. The vehicle M which has made a reservation after the entry can complete other tasks by the expected time and use the parking lot by visiting the parking lot again. As a result, convenience of the user is improved. For example, the user can effectively use time.

### Scene 1

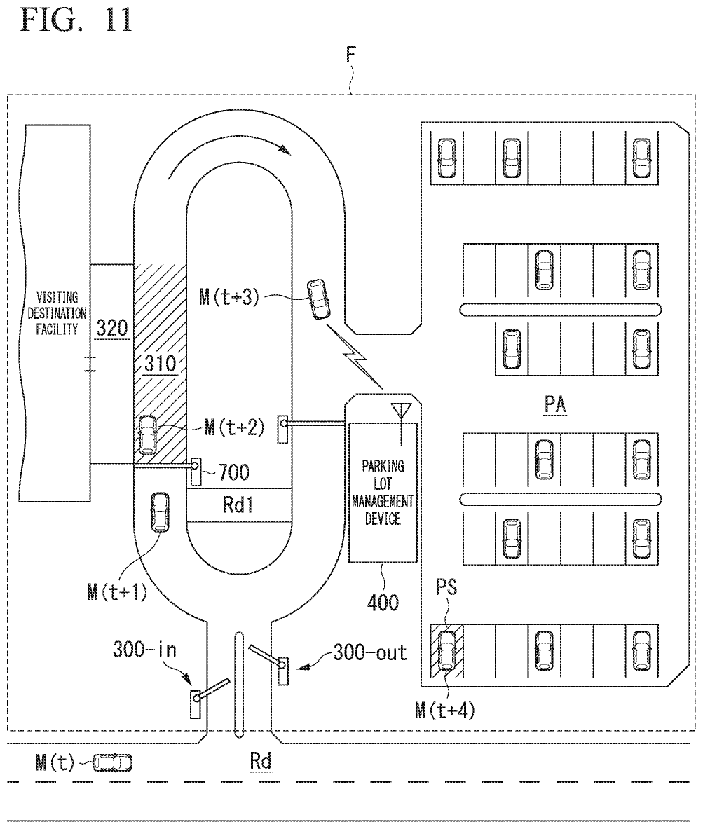

FIG. 11 is a diagram which shows an example of a scene in which the processing of step S104 is performed. It is assumed that the vehicle M has passed through the gate 300-in after reaching near the gate 300-in at a time t, and the vehicle M has reached the specific gate device 700 at a time t+1. In this case, when there is a parking space available within the first predetermined time, the vehicle M stops at the stop area 310 at a time t+2, and travels toward the parking lot PA at a time t+3. Then, the vehicle M parks in the parking space PS at a time t+4.

As described above, when there is a parking space available within the first predetermined time, the vehicle M can use the parking lot PA without leaving the facility. As a result, the convenience of the user is improved.

### Scene 2

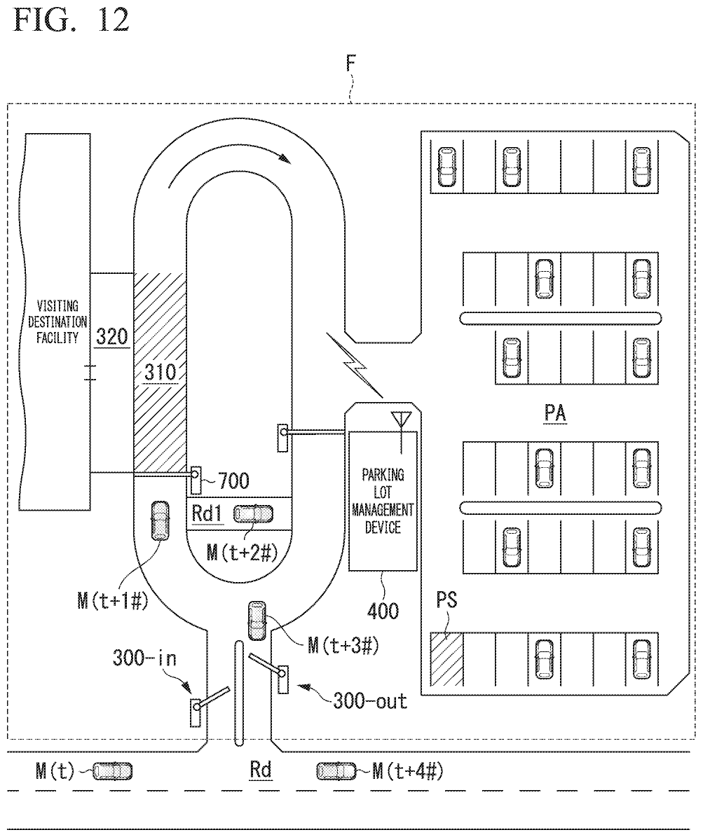

FIG. 12 is a diagram which shows an example of a scene in which processing for a post-entry reservation is performed. It is assumed that the vehicle M has passed through the gate 300-in after reaching near the gate 300-in at the time t, and the vehicle M has reached the specific gate device 700 at a time t+1#. In this case, when there is no parking space available within the first predetermined time, the user of the vehicle M makes, for example, a post-entry reservation. The vehicle M travels on the U-turn road Rd1 at a time t+2#, and travels toward the gate 300-out at a time t+3#. Then, the vehicle M travels on the road Rd at a time t+4#.

Then, when the vehicle M has visited the facility including the parking lot PA again at a time associated with the post-entry reservation, the vehicle M can use the parking lot PA. That is, the controller 420 of the parking lot management device 400 allows the first vehicle to use the parking lot in a case in which the first vehicle of the user provided with the first information exits from the facility and enters the facility again at a time according to the first information. To allow means, for example, controlling a gate of the gate 300-in or a gate of the specific gate device 700 such that it is open to enable the vehicle to park in the parking lot PA, managing the vehicle in the parking space state table 434, guiding, by the parking lot management device 400, the vehicle to the parking space PS, or the like.

“A time according to the first information” is a time in which there is a parking space in which the first vehicle can park in the parking lot, and the priority level of the first post-entry reservation becomes higher than the priority level of a post-entry reservation received after another vehicle enters the facility.

As described above, when there is no parking space available within the first predetermined time, the vehicle M has made a post-entry reservation, temporarily exited the facility, and visited the facility again, the vehicle can use the parking lot PA on the basis of the post-entry reservation. As a result, the convenience of the user is improved.

### Processing at the Time of Entry

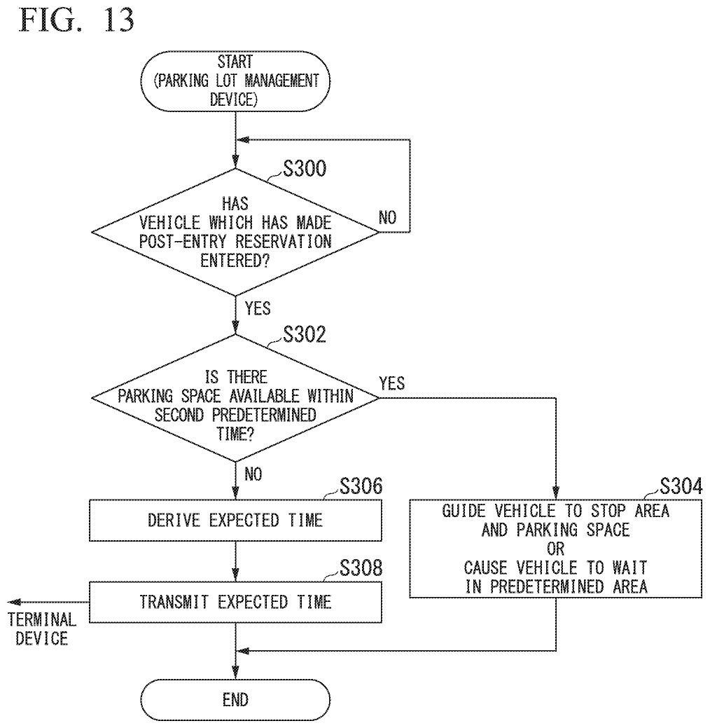

FIG. 13 is a flowchart which shows an example of a flow of processing executed when the vehicle M having made a post-entry reservation enters.

First, the use manager 424 of the parking lot management device 400 determines whether the vehicle M which has made a post-entry reservation has entered (step S300). For example, the use manager 424 determines whether the vehicle M which has made a post-entry reservation has entered on the basis of the post-entry reservation information 438 and an image captured by a camera provided near the gate 300-in.

When the vehicle M which has made a post-entry reservation has entered, the use manager 424 determines whether there is a parking space available within a second predetermined time (step S302). The use manager 424 refers to, for example, the parking space state table 434 and the pre-entry reservation information 436, and determines whether there is an available parking space. The second predetermined time is, for example, a time which is longer than the first predetermined time. As a result, the convenience of the user is improved by alleviating conditions for the use of the parking lot for the vehicle M which has made a post-entry reservation.

When there is a parking space available within the second predetermined time, the parking lot management device 400 guides the vehicle M to the stop area 310 and the parking space PS (step S304). When there is a short time before the parking space PS becomes empty, the parking lot management device 400 causes the vehicle M to wait in a predetermined area (for example, the stop area 310).

When there is no parking space available within the second predetermined time, the information processor 426 of the parking lot management device 400 derives an expected time during which the parking lot can be used (step S306), and transmits the derived expected time to the terminal device 600 (step S308). As a result, processing of this flowchart ends.

As described above, when the vehicle M which has made a post-entry reservation has entered the facility at a time according to the post-entry reservation, the vehicle M can use the parking lot. As a result, the convenience of the user is improved.

According to the first embodiment described above, the parking lot management device 400 refers to the usage status of the parking lot, and, when the first vehicle having entered the facility including the parking lot cannot use the parking lot within predetermined time after the entry, receives the first post-entry reservation for the use of the parking lot of the first vehicle and is configured to provide the user of the first vehicle with the first information on the received first post-entry reservation, thereby improving the convenience for the user.

### Second Embodiment

A second embodiment will be described. In the first embodiment, it is assumed that the vehicle M makes a post-entry reservation after passing through the gate 300-in. On the other hand, the vehicle M makes a post-entry reservation before passing through the gate 300-in in the second embodiment. In the following description, a difference from the first embodiment will be described.

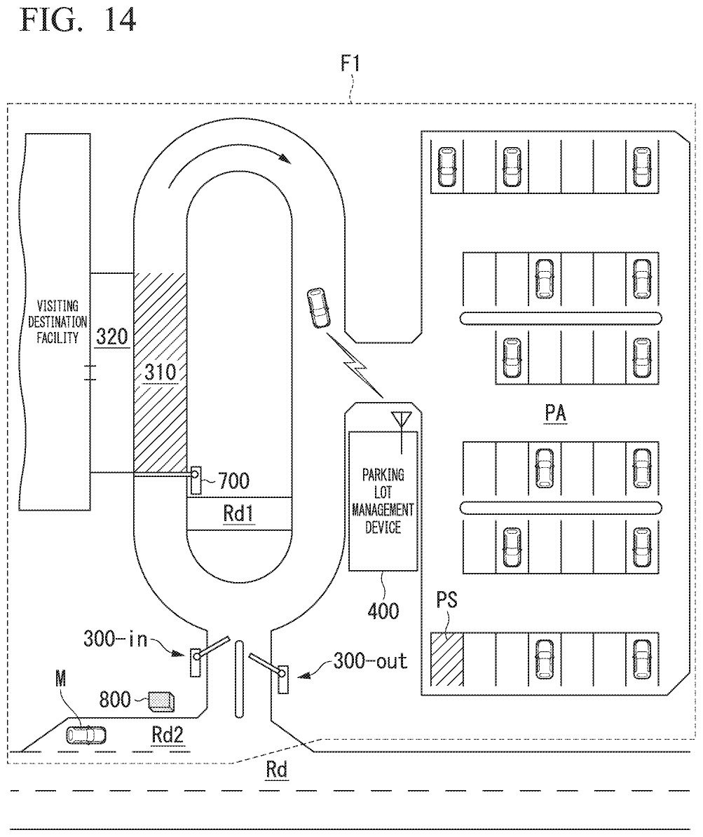

FIG. 14 is a diagram which shows an example of a configuration of a facility F1 of the second embodiment. For example, the facility F1 of the second embodiment includes a branch road Rd2 that branches from the road Rd. The vehicle M can enter the branch road Rd2 from the road Rd, and pass through the gate 300-in by turning left from the branch road Rd2. A specific terminal device 800 and a specific camera (not shown) that captures an image of the vehicle M are provided near the branch road Rd2.

The specific terminal device 800 and the camera communicate with the parking lot management device 400. The specific terminal device 800 has a function equivalent to, for example, the specific gate device 700 of the first embodiment. A display of the specific terminal device 800 displays the availability of the parking lot on the basis of information provided to the parking lot management device 400. For example, when the vehicle M of a user who has not made a pre-entry reservation reaches near the branch road Rd2, the specific camera captures the image of the vehicle M. The captured image is transmitted to the parking lot management device 400. The parking lot management device 400 analyzes the captured image and acquires, for example, information on a license plate of the vehicle M. Then, the parking lot management device 400 executes the processing described in the flowchart of FIG. 7 described above, and receives a pre-entry reservation. In this case, the processing of the specific gate device 700 in the flowchart of FIG. 7 is executed by the specific terminal device 800.

When there is a parking space available within the first predetermined time according to the parking lot management device 400 and the specific terminal device 800 performing processing equivalent to the processing described in the flowchart of FIG. 7, the vehicle M can use the parking lot PA without exiting the facility F1. When there is no parking space available within the first predetermined time, the vehicle M can make a post-entry reservation, and use the parking lot PA on the basis of the post-entry reservation when it temporarily exits from the facility F1 and visits the facility F1 again. As a result, the convenience of the user is improved.

When the vehicle M which has made a post-entry reservation enters, the following processing is executed. For example, if the vehicle M reaches near the specific terminal device 800, the parking lot management device 400 identifies the vehicle M on the basis of the image captured by the specific camera and determines whether the identified vehicle M is a vehicle that can enter. For example, when it is determined that the vehicle M is a vehicle that has made a post-entry reservation and it is a time associated with the post-entry reservation, the parking lot management device 400 causes the display of the specific terminal device 800 to display information indicating that the vehicle M can enter. Then, the parking lot management device 400 sets the gate 300-in and the specific gate device 700 to be open and causes the vehicle M to park in the parking lot. When the vehicle M that has made a post-entry reservation has reached near the specific terminal device 800 before the second predetermined time, the vehicle M passes through the specific terminal device 800, and, when it has reached the gate 300-in, a gate of the gate 300-in is opened and the vehicle M passes through the U-turn road Rd1 and exits from the facility F1.

According to the second embodiment described above, when the specific terminal device 800 is provided before the vehicle passes through the gate 300-in, the parking lot management device 400 receives a post-entry reservation before the gate 300-in, thereby achieving the same effects as in the first embodiment.

### Hardware Configuration

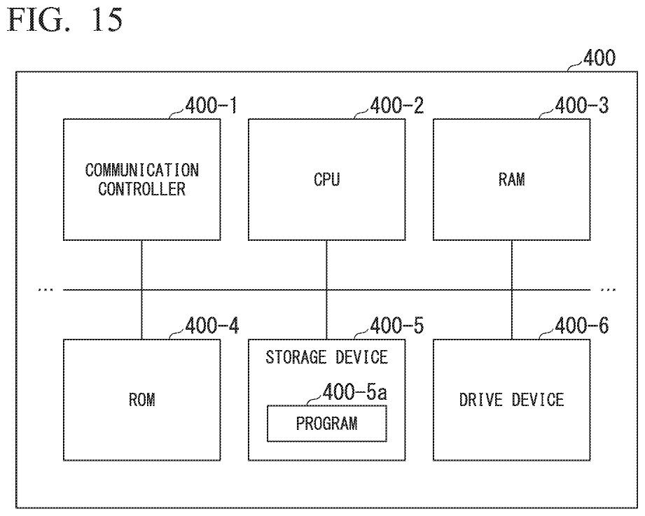

FIG. 15 is a diagram which shows an example of a hardware configuration of the parking lot management device 400 of the embodiment. As shown in FIG. 15, the parking lot management device 400 is configured to include a communication controller 400-1, a CPU 400-2, a random access memory (RAM) 400-3 used as a working memory, a read only memory (ROM) 400-4 that stores a booting program and the like, a storage device 400-5 such as a flash memory or a hard disk drive (HDD), a drive device 400-6, and the like connected to one another by an internal bus or a dedicated communication line. The communication controller 400-1 communicates with components other than the automated driving control device 400. The storage device 400-5 stores a program 400-5a executed by the CPU 400-2. This program is developed in the RAM 400-3 by a direct memory access (DMA) controller (not shown) or the like, and is executed by the CPU 400-2. Accordingly, some or all of the controller 420 (the reservation manager 422, the use manager 424, the information processor 426, and the provider 428) are realized. The automated driving control device 100, similarly to the above description, is configured to include a communication controller, a CPU, a RAM, a ROM, a storage device, a drive device, and the like being connected to each other by an internal bus or a dedicated communication line. Then, the program stored in the storage device is executed by the CPU, and thereby the first controller 120 and the second controller 160 perform various types of processing.

The embodiments described above can be expressed as follows.

A vehicle control device is configured to include a storage device which stores a program, and a hardware processor, in which the hardware processor executes the program stored in the storage device, thereby acquiring an availability status of a parking lot, referring to the acquired usage status, and, when a first vehicle having entered a facility including a parking lot cannot use the parking lot within predetermined time after the entry, receiving a first post-entry reservation for a use of the parking lot of the first vehicle, and providing a user of the first vehicle with first information on the received first post-entry reservation.

As described above, the forms for implementing the present invention have been described using the embodiments. However, the present invention is not limited to such embodiments, and various modifications and substitutions may be added in a range not departing from the gist of the present invention.

What is claimed is:

1. A management device comprising:
an acquirer configured to acquire a usage status of a parking lot;
an information processor configured to refer to the usage status acquired by the acquirer and, when a first vehicle having entered a facility including a parking lot cannot use the parking lot within a predetermined time after the entry, to receive a first post-entry reservation for the use of the parking lot of the first vehicle; and
a provider configured to provide a user of the first vehicle with first information on the first post-entry reservation received by the information processor.

2. The management device according to claim 1, further comprising:
a controller configured to allow the first vehicle to use the parking lot in a case in which the first vehicle of the user provided with the first information has exited from the facility and has entered the facility again at a time according to the first information.

3. The management device according to claim 2,
wherein the first vehicle is a vehicle which has not made a pre-entry reservation for a use of the parking lot performed before entry, and
the controller, when a second vehicle of a user who has made a pre-entry reservation has entered the facility at a time according to the pre-entry reservation, is configured to allow the second vehicle to use the parking lot.

4. The management device according to claim 2,
wherein a time according to the first information is a time in which a parking space in which the first vehicle can park is present in the parking lot, and a priority level of the first post-entry reservation is higher than a priority level of a second post-entry reservation received after another vehicle has entered the facility.

5. The management device according to claim 1, further comprising:
a provider configured to refer to the first post-entry reservation, a third post-entry reservation which has a higher priority level than the first post-entry reservation for the use of the parking lot and is received after another vehicle has entered the facility, and the usage status of the parking lot, and to provide the user with a time during which the first vehicle can use the parking lot.

6. The management device according to claim 1,
wherein the usage status includes a use time included in a pre-entry reservation that is received before a vehicle enters the facility for the use of the parking lot.

7. The management device according to claim 1, further comprising:
a provider configured to provide the user with information indicating the number of fourth post-entry reservations which have higher priority levels than the first post-entry reservation for the use of the parking lot and are received after another vehicle has entered the facility.

8. The management device according to claim 1,
wherein the first information is information on fifth post-entry reservations received after vehicles have entered the facility, which have an increasing priority level in order of entry into the facility.

9. The management device according to claim 1,
wherein the provider is configured to provide a terminal device of a user or a vehicle used by the user with the first information.

10. The management device according to claim 1,
wherein the provider is configured to provide the terminal device of the user or the vehicle used by the user with a time according to the first information during which the first vehicle can use the parking lot.

11. A management method comprising:
by a computer,
acquiring a usage status of a parking lot;
referring to the acquired usage status, and, when a first vehicle having entered a facility including a parking lot cannot use the parking lot within a predetermined time after the entry, receiving a first post-entry reservation for a use of the parking lot of the first vehicle; and
providing a user of the first vehicle with first information on the received first post-entry reservation.

12. A non-transitory computer-readable storage medium that is configured to store a computer program to be executed by a computer to perform at least:
acquire a usage status of a parking lot;
referring to the acquired usage status, and, when a first vehicle having entered a facility including a parking lot cannot use the parking lot within a predetermined time after the entry, receiving a first post-entry reservation for a use of the parking lot of the first vehicle; and
provide a user of the first vehicle with first information on the received first post-entry reservation.
